(19) United States
(12) Patent Application Publication
(10) Pub. No.: US 2026/0149977 A1
(43) Pub. Date: May 28, 2026

(54) BEAM ADJUSTMENT USING BEAM TILTING

(71) Applicant: QUALCOMM Incorporated, San Diego, CA (US)

(72) Inventors: Ahmed KHAN, Hyderabad (IN); Rajesh NAGANATHAN, Hyderabad (IN); Saurabh SHANDILYA, New Delhi (IN)

(21) Appl. No.: 18/958,831

(22) Filed: Nov. 25, 2024

(51) Int. Cl. H04W 16/28; H04B 7/0426

(52) U.S. Cl. CPC H04W 16/28; H04B 7/043

(57) ABSTRACT

Various aspects of the present disclosure generally relate to wireless communication. In some aspects, a network node may obtain a boresight beam having a reference azimuth characteristic and a reference elevation characteristic. The network node may apply a tilt operation to the boresight beam to obtain a tilted boresight beam. The network node may steer the tilted boresight beam in accordance with an azimuth parameter and an elevation parameter. The network node may transmit information associated with the tilted boresight beam based at least in part on steering the tilted boresight beam in accordance with the azimuth parameter and the elevation parameter. Numerous other aspects are described.

### FIELD OF THE DISCLOSURE

Aspects of the present disclosure generally relate to wireless communication and specifically relate to techniques, apparatuses, and methods associated with beam adjustment using beam tilting.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIGS. 3A-3B are diagrams illustrating examples of analog beamforming and elongated beams, in accordance with the present disclosure.

FIG. 4 is a diagram illustrating an example of beam adjustment using beam tilting, in accordance with the present disclosure.

FIGS. 5A-5D are diagrams illustrating examples of beam tilting and beam steering, in accordance with the present disclosure.

FIG. 6 is a diagram illustrating an example of beam tilting in accordance with user equipment (UE) characteristics, in accordance with the present disclosure.

FIG. 7 is a diagram illustrating an example process performed, for example, at a network node or an apparatus of a network node, in accordance with the present disclosure.

FIG. 8 is a diagram illustrating an example process performed, for example, at a UE or an apparatus of a UE, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### SUMMARY

Some aspects described herein relate to a method of wireless communication performed by a network node. The method may include obtaining a boresight beam having a reference azimuth characteristic and a reference elevation characteristic. The method may include applying a tilt operation to the boresight beam to obtain a tilted boresight beam. The method may include steering the tilted boresight beam in accordance with an azimuth parameter and an elevation parameter. The method may include transmitting information associated with the tilted boresight beam based at least in part on steering the tilted boresight beam in accordance with the azimuth parameter and the elevation parameter.

Some aspects described herein relate to a method of wireless communication performed by a user equipment (UE). The method may include transmitting one or more characteristics of the UE. The method may include receiving information associated with a tilted boresight beam, wherein the tilted boresight beam is tilted in accordance with the one or more characteristics of the UE and is steered in accordance with an azimuth parameter and an elevation parameter. The method may include communicating with a network node using the tilted boresight beam.

Some aspects described herein relate to an apparatus for wireless communication at a network node. The apparatus may include one or more memories and one or more processors coupled to the one or more memories. The one or more processors may be configured to obtain a boresight beam having a reference azimuth characteristic and a reference elevation characteristic. The one or more processors may be configured to apply a tilt operation to the boresight beam to obtain a tilted boresight beam. The one or more processors may be configured to steer the tilted boresight beam in accordance with an azimuth parameter and an elevation parameter. The one or more processors may be configured to transmit information associated with the tilted boresight beam based at least in part on steering the tilted boresight beam in accordance with the azimuth parameter and the elevation parameter.

Some aspects described herein relate to an apparatus for wireless communication at a UE. The apparatus may include one or more memories and one or more processors coupled to the one or more memories. The one or more processors may be configured to transmit one or more characteristics of the UE. The one or more processors may be configured to receive information associated with a tilted boresight beam, wherein the tilted boresight beam is tilted in accordance with the one or more characteristics of the UE and is steered in accordance with an azimuth parameter and an elevation parameter. The one or more processors may be configured to communicate with a network node using the tilted boresight beam.

Some aspects described herein relate to a non-transitory computer-readable medium that stores a set of instructions for wireless communication by a network node. The set of instructions, when executed by one or more processors of the network node, may cause the network node to obtain a boresight beam having a reference azimuth characteristic and a reference elevation characteristic. The set of instructions, when executed by one or more processors of the network node, may cause the network node to apply a tilt operation to the boresight beam to obtain a tilted boresight beam. The set of instructions, when executed by one or more processors of the network node, may cause the network node to steer the tilted boresight beam in accordance with an azimuth parameter and an elevation parameter. The set of instructions, when executed by one or more processors of the network node, may cause the network node to transmit information associated with the tilted boresight beam based at least in part on steering the tilted boresight beam in accordance with the azimuth parameter and the elevation parameter.

Some aspects described herein relate to a non-transitory computer-readable medium that stores a set of instructions for wireless communication by a UE. The set of instructions, when executed by one or more processors of the UE, may cause the UE to transmit one or more characteristics of the UE. The set of instructions, when executed by one or more processors of the UE, may cause the UE to receive information associated with a tilted boresight beam, wherein the tilted boresight beam is tilted in accordance with the one or more characteristics of the UE and is steered in accordance with an azimuth parameter and an elevation parameter. The set of instructions, when executed by one or more processors of the UE, may cause the UE to communicate with a network node using the tilted boresight beam.

Some aspects described herein relate to an apparatus for wireless communication. The apparatus may include means for obtaining a boresight beam having a reference azimuth characteristic and a reference elevation characteristic. The apparatus may include means for applying a tilt operation to the boresight beam to obtain a tilted boresight beam. The apparatus may include means for steering the tilted boresight beam in accordance with an azimuth parameter and an elevation parameter. The apparatus may include means for transmitting information associated with the tilted boresight beam based at least in part on steering the tilted boresight beam in accordance with the azimuth parameter and the elevation parameter.

Some aspects described herein relate to an apparatus for wireless communication. The apparatus may include means for transmitting one or more characteristics of the apparatus. The apparatus may include means for receiving information associated with a tilted boresight beam, wherein the tilted boresight beam is tilted in accordance with the one or more characteristics of the apparatus and is steered in accordance with an azimuth parameter and an elevation parameter. The apparatus may include means for communicating with a network node using the tilted boresight beam.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Wireless communication networks may employ phased arrays with large numbers of antennas for analog beamforming. Beams to be used for the wireless communications may be defined using a codebook, where each codebook entry in the codebook indicates one or more phases of an antenna for transmitting the beam. A network node may select a beam having an azimuth characteristic θ_{az} and an elevation characteristic θₑₗ and may employ a phase shifting operation to shift a phase of the beam to obtain a phased array. A codebook may be loaded into a radio frequency integrated circuit (RFIC) memory of the network node. The codebook may include beams that cover a certain field of view (FOV). However, codebook RFIC memory may be limited and may not be capable of storing beams aligned to all possible UE trajectories.

A codebook design may include narrow beams and elongated beams. The elongated beams may be elongated in the azimuth direction. For example, a fixed millimeter wave (mmWave) beamformer may transmit a plurality of beams that are elongated only in the azimuth direction. Terminals in high-rise buildings may communicate with the network node using the elongated beams. Additionally, or alternatively, terminals on city streets may communicate with the network node using the elongated beams. Using beams that are elongated only in the azimuth direction may be suitable for certain scenarios where terminals are moving at the same elevation and in the same general direction as the beams, such as in high-rise buildings and on city streets. However, using beams that are elongated only in the azimuth direction may not be suitable for other scenarios, such as satellite beams or beams directed at vehicles. In some cases, using beams that are elongated only in the azimuth direction may result in reduced signal quality and strength. For example, when beams elongated only in the azimuth direction are misaligned, a signal strength received at a terminal (such as a user equipment (UE)) may be lower, thereby resulting in a higher signal-to-noise ratio (SNR). Additionally, when beams elongated only in the azimuth direction are not aligned with a movement direction of the UE, the UE may frequently move out of coverage of the beams, thereby resulting in frequent beam switching and handoffs. In some cases, misalignment between the UE movement direction and beams elongated only in the azimuth direction can result in sudden losses of connectivity, particularly in mmWave bands and in urban environments where the beams are narrow and sensitive to misalignment. In some cases, using beams that are elongated only in the azimuth direction may result in wasted energy resources, for example, since the network node may be required to boost its power to maintain a stable connection with the UE. Further, using beams that are elongated only in the azimuth direction may increase difficulty in predictive beamforming.

Various aspects relate generally to wireless communications. Some aspects more specifically relate to beam adjustment using beam tilting. In some aspects, a network node may obtain a boresight beam having a reference azimuth characteristic and a reference elevation characteristic. The reference azimuth characteristic may indicate that the boresight beam is pointing in a reference azimuth direction and the reference elevation characteristic may indicate that the boresight beam is at a reference elevation. For example, the reference azimuth characteristic may indicate that the boresight beam is pointing in a horizontal direction with respect to one or more antennas of the network node, and the reference elevation characteristic may indicate that the elevation of the boresight beam corresponds to an elevation of the one or more antennas of the network node. The network node may apply a tilt operation to the boresight beam to obtain a tilted boresight beam. In some aspects, applying the tilt operation to the boresight beam may include performing a coordinate-rotation-based phase-remapping operation to one or more antennas used for transmitting the boresight beam. Additionally, or alternatively, applying the tilt operation to the boresight beam may include performing an electrical rotation of the boresight beam based at least in part on mapping one or more antenna element phases to one or more elements located at one or more rotated positions associated with the tilt operation, where a phase of an antenna element used for the tilted boresight beam is equal to a phase of an antenna element of a non-tilted boresight beam at a corresponding rotated location. The network node may steer the tilted boresight beam in accordance with an azimuth parameter and an elevation parameter. In some aspects, steering the tilted boresight beam may include adjusting the tilted boresight beam to a same direction as the original beam and to a same elevation as the original beam. The network node may transmit information associated with the tilted boresight beam based at least in part on steering the tilted boresight beam in accordance with the azimuth parameter and the elevation parameter. For example, the network node may transmit the information associated with the tilted boresight beam to a UE and may communicate with the UE using the tilted boresight beam.

Particular aspects of the subject matter described in this disclosure can be implemented to realize one or more of the following potential advantages. In some examples, by enabling the network node to communicate with a UE (or other device) using a tilted boresight beam, the described techniques can be used to enable increased signal quality and strength of the beams. For example, by enabling the network node to communicate with the UE using the tilted boresight beam, the described techniques can be used to increase an SNR for communications with the UE. In some examples, by enabling the network node to communicate with the UE using the tilted boresight beam, the described techniques can be used to reduce beam switching and handoff frequency. In some examples, by enabling the network node to communicate with the UE using the tilted boresight beam, the described techniques can be used to reduce sudden losses of connectivity between the network node and the UE, such as in mmWave bands and in urban environments. In some examples, by enabling the network node to communicate with the UE using the tilted boresight beam, the described techniques can be used to reduce power consumption by the network node and the UE. In some examples, by enabling the network node to communicate with the UE using the tilted boresight beam, the described techniques can be used to increase predictive beamforming accuracy. These example advantages, among others, are described in more detail below.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

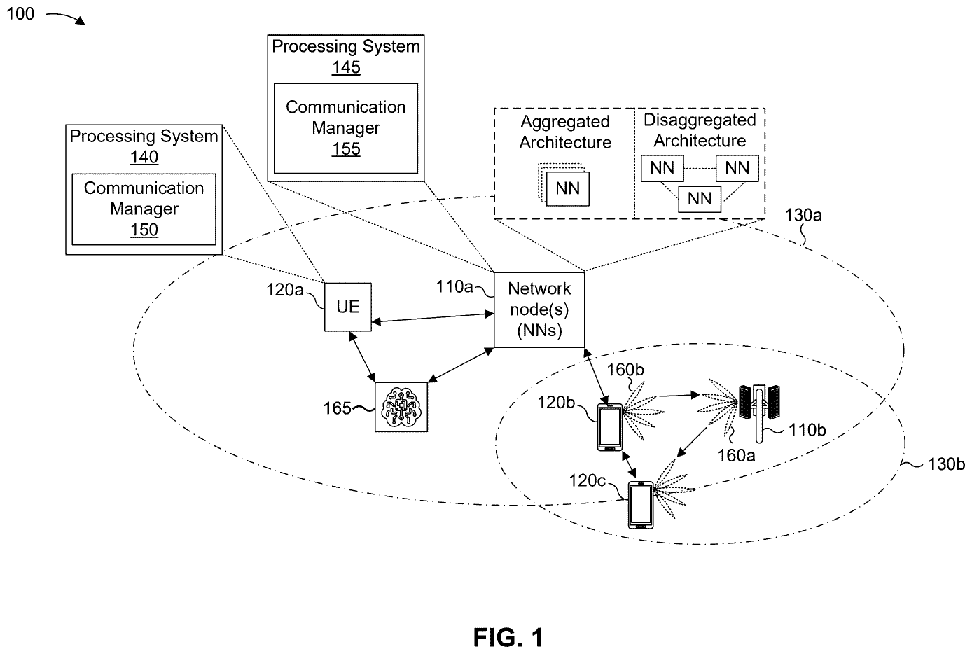

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as the processing system 140 and/or the processing system 145. In some examples, each of the antenna elements of an antenna may include one or more sub-elements for radiating or receiving RF signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range. In some examples, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

Further efficiencies in throughput, signal strength, and/or other signal properties may be achieved through beam refinement. For example, the network node 110 may be capable of communicating with the UE 120 using beams (for example, beam(s) 160a) of different beam widths. In some examples, the network node 110 may be configured to utilize a wider beam to communicate with the UE 120 when the UE 120 is in motion or for initial beam acquisition because wider coverage may increase the likelihood that the mobile UE 120 remains in coverage of the network node 110 while communicating using the wider beam. Conversely, the network node 110 may use a narrower beam to communicate with the UE 120 when the UE 120 is stationary because the network node 110 can reliably focus coverage on the UE 120 with low or minimal likelihood of the UE 120 moving out of the coverage area of the narrower beam. In some examples, to select a particular beam (for example, from the beam(s) 160a) for communication with a UE 120, the network node 110 may transmit a reference signal, such as a synchronization signal block (SSB) or a channel state information (CSI) reference signal (CSI-RS), on each of a plurality of beams in a beam-sweeping manner. In some examples, SSBs may be transmitted on wider beams, whereas CSI-RSs may be transmitted on narrower beams. The UE 120 may measure the reference signal received power (RSRP) or the signal-to-interference-plus-noise ratio (SINR) on each of the beams and transmit a beam measurement report (for example, a Layer 1 (L1) measurement report) to the network node 110 indicating the RSRP or SINR associated with each of one or more of the measured beams. The network node 110 may then select the particular beam for communication with the UE 120 based on the L1 measurement report. In some other examples, when there is channel reciprocity between the uplink and the downlink, the network node 110 may derive the particular beam to communicate with the UE 120 (for example, on both the uplink and downlink) based on uplink measurements of one or more uplink reference signals, such as a sounding reference signal (SRS), transmitted by the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

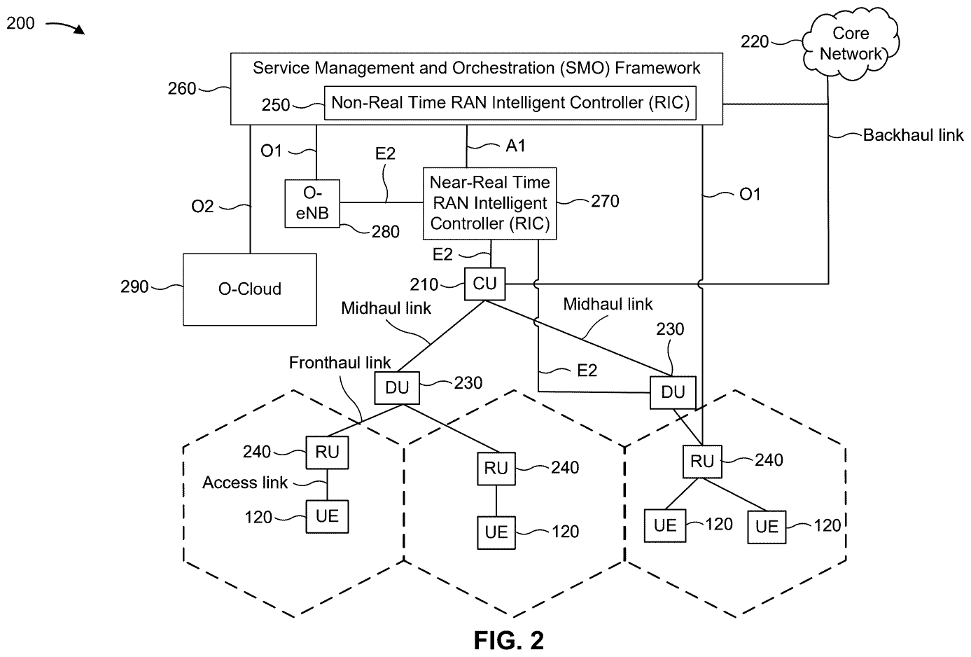

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUS). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SSB (for example, that includes a PSS, an SSS, and a physical broadcast channel (PBCH)), a demodulation reference signal (DMRS), a phase tracking reference signal (PTRS), a tracking reference signal (TRS), and a CSI-RS, among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include an SRS, a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-RSRP parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mm Wave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the network node 110 may include a communication manager 155. As described in more detail elsewhere herein, the communication manager 155 may obtain a boresight beam having a reference azimuth characteristic and a reference elevation characteristic; apply a tilt operation to the boresight beam to obtain a tilted boresight beam; steer the tilted boresight beam in accordance with an azimuth parameter and an elevation parameter; and transmit information associated with the tilted boresight beam based at least in part on steering the tilted boresight beam in accordance with the azimuth parameter and the elevation parameter. Additionally, or alternatively, the communication manager 155 may perform one or more other operations described herein.

In some aspects, the UE 120 may include a communication manager 150. As described in more detail elsewhere herein, the communication manager 150 may transmit one or more characteristics of the UE; receive information associated with a tilted boresight beam, wherein the tilted boresight beam is tilted in accordance with the one or more characteristics of the UE and is steered in accordance with an azimuth parameter and an elevation parameter; and communicate with a network node using the tilted boresight beam. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

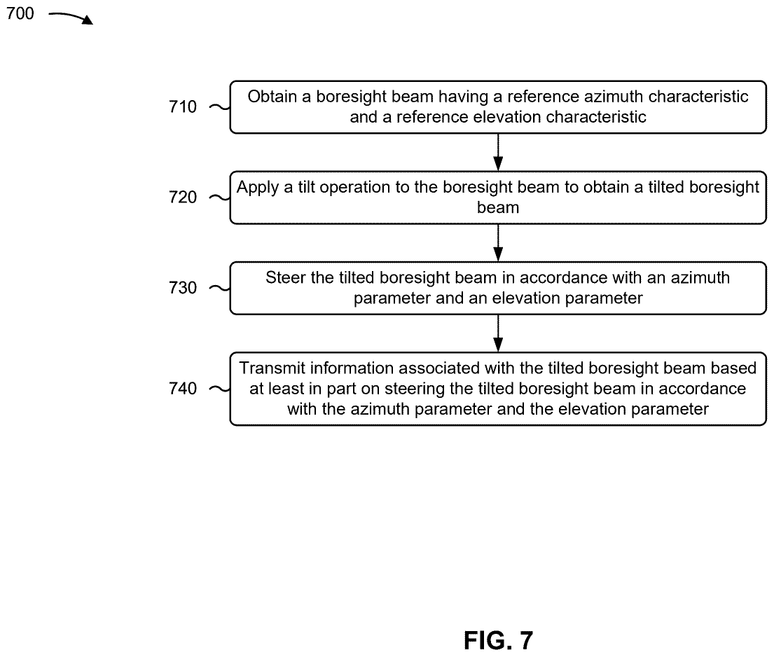

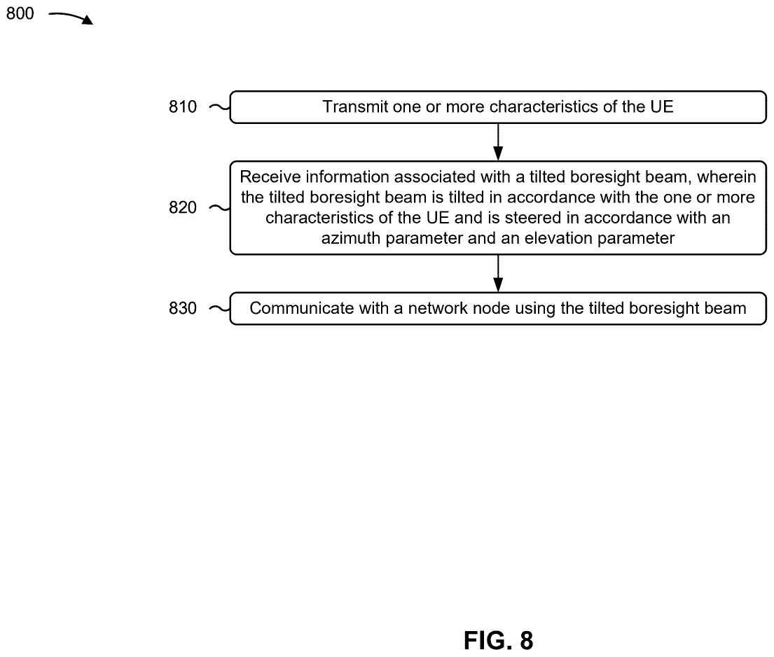

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with beam adjustment using beam tilting, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

In some aspects, the network node 110 includes means for obtaining a boresight beam having a reference azimuth characteristic and a reference elevation characteristic; means for applying a tilt operation to the boresight beam to obtain a tilted boresight beam; means for steering the tilted boresight beam in accordance with an azimuth parameter and an elevation parameter; and/or means for transmitting information associated with the tilted boresight beam based at least in part on steering the tilted boresight beam in accordance with the azimuth parameter and the elevation parameter. The means for the network node 110 to perform operations described herein may include, for example, one or more of communication manager 155, processing system 145, a radio, one or more RF chains, one or more transceivers, one or more antennas, one or more modems, a reception component, and/or a transmission component, among other examples.

In some aspects, the UE 120 includes means for transmitting one or more characteristics of the UE; means for receiving information associated with a tilted boresight beam, wherein the tilted boresight beam is tilted in accordance with the one or more characteristics of the UE and is steered in accordance with an azimuth parameter and an elevation parameter; and/or means for communicating with a network node using the tilted boresight beam. The means for the UE 120 to perform operations described herein may include, for example, one or more of communication manager 150, processing system 140, a radio, one or more RF chains, one or more transceivers, one or more antennas, one or more modems, a reception component, and/or a transmission component, among other examples.

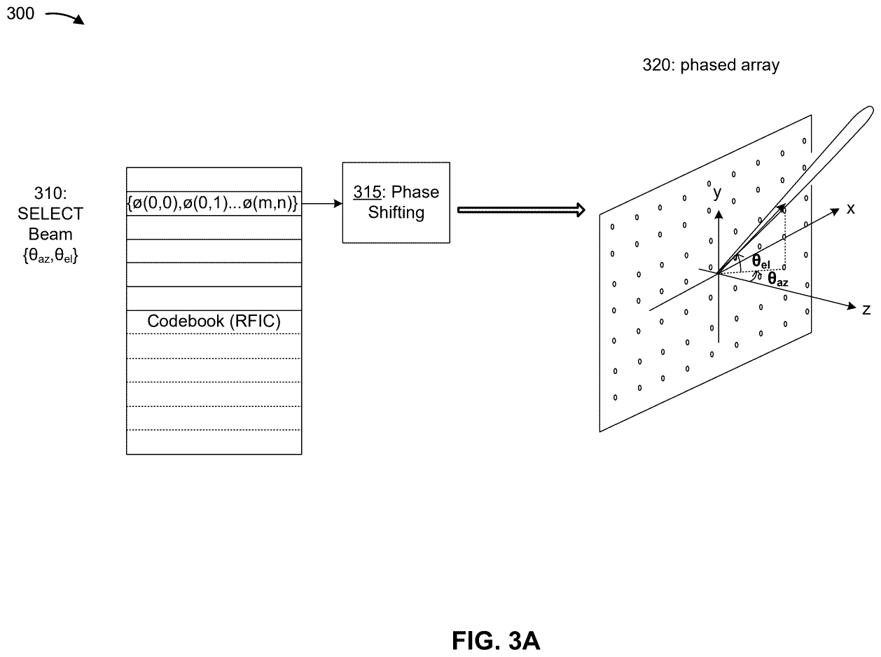

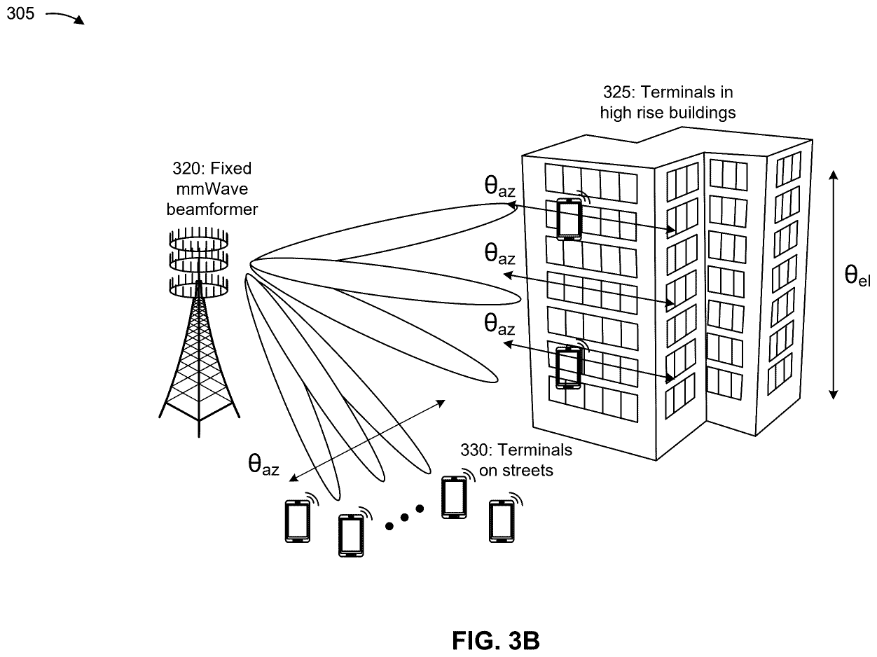

FIGS. 3A-3B are diagrams illustrating examples 300 and 305 of analog beamforming and elongated beams, in accordance with the present disclosure.

Wireless communication networks may employ phased arrays with large numbers of antennas for analog beamforming. Beams to be used for the wireless communications may be defined using a codebook, where each codebook entry in the codebook indicates one or more phases of an antenna for transmitting the beam. As shown in the example 300 and by reference number 310, a network node 110 may select a beam having an azimuth characteristic θ_{az} and an elevation characteristic θₑₗ. As shown by reference number 315, the network node 110 may employ a phase shifting operation to shift a phase of the beam. As shown by reference number 320, the network node 110 may obtain a phased array that is in accordance with the phase shifted azimuth characteristic θ_{az} and elevation characteristic θₑₗ. A codebook may be loaded into an RFIC memory of the network node 110. The codebook may include beams that cover a certain field of view. However, codebook RFIC memory may be limited. Therefore, codebooks may need to be carefully designed for a desired FOV coverage. As shown in FIG. 3B and the example 305, a codebook design may include narrow beams and elongated beams. The elongated beams may be elongated in the azimuth direction. For example, as shown by reference number 320, a fixed mm Wave beamformer may transmit a plurality of beams that are elongated only in the azimuth direction. As shown by reference number 325, terminals (such as UEs 120) in high-rise buildings may communicate with the network node 110 using the elongated beams. Additionally, or alternatively, as shown by reference number 330, terminals on city streets may communicate with the network node 110 using the elongated beams. Using beams that are elongated only in the azimuth direction may be suitable for certain scenarios where terminals are moving at the same elevation and in the same general direction, such as in the high-rise buildings and the streets described above. However, using beams that are elongated only in the azimuth direction may not be suitable for other scenarios, such as satellite beams or beams directed at vehicles.

As indicated above, FIG. 3 is provided as an example. Other examples may differ from what is described with regard to FIG. 3.

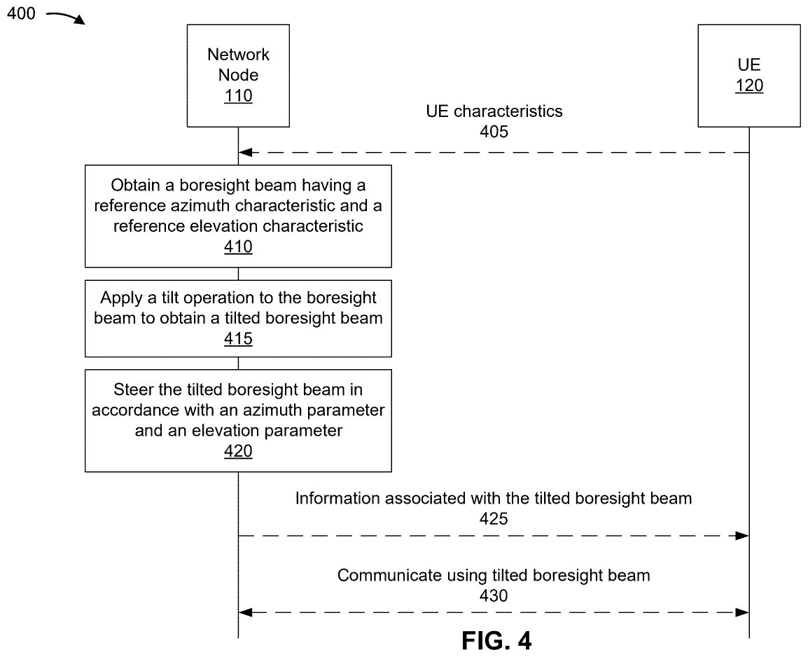

FIG. 4 is a diagram illustrating an example 400 of beam adjustment using beam tilting, in accordance with the present disclosure.

As shown by reference number 405, the UE 120 may transmit, and the network node 110 may receive, one or more characteristics of the UE 120. In some aspects, the one or more characteristics of the UE 120 may include location information associated with the UE 120 and velocity information associated with the UE 120. In some other aspects, the one or more characteristics of the UE 120 may include only the location information associated with the UE 120. In some aspects, the one or more characteristics of the UE 120 may include satellite information associated with a satellite in communication with the UE 120. In some aspects, the one or more characteristics of the UE 120 may include one or more throughput metrics associated with the UE 120.

As shown by reference number 410, the network node 110 may obtain a boresight beam having a reference azimuth characteristic and a reference elevation characteristic. In some aspects, obtaining the boresight beam may include transforming an original beam into a boresight beam, where the original beam is a non-tilted beam having an azimuth characteristic that is in accordance with an indicated azimuth parameter and an elevation characteristic that is in accordance with an indicated elevation parameter. For example, the network node 110 may obtain a non-tilted beam from a codebook pointing at (θ_{az}, θₑₗ) and may transform the non-tilted beam into a boresight beam. The reference azimuth characteristic may indicate that the boresight beam is pointing in a reference azimuth direction and the reference elevation characteristic may indicate that the boresight beam is at a reference elevation. The reference azimuth direction may be a horizontal direction with respect to one or more antennas of the network node 110 and the reference elevation may be an elevation of the one or more antennas of the network node 110.

In some aspects, obtaining the boresight beam may include selecting the boresight beam in accordance with an azimuth half-power beam width (HBPW) of the boresight beam and an elevation HBPW of the boresight beam. For example, the network node 110 may store a plurality of beams in a memory of the network node 110, each beam of the plurality of beams having a different azimuth HBPW and a different elevation HBPW. The network node 110 may select a boresight beam having a certain HBPW in accordance with the one or more characteristics of the UE 120 (or another terrestrial device).

As shown by reference number 415, the network node 110 may apply a tilt operation to the boresight beam. Applying the tilt operation to the boresight beam may result in a tilted boresight beam. For example, the network node 110 may apply a tilt that is represented by Ω_{Tilt}. In some aspects, applying the tilt operation to the boresight beam may include performing a coordinate-rotation-based phase-remapping operation to one or more antennas used for transmitting the boresight beam.

In some examples, applying the tilt operation to the boresight beam may include performing an electrical rotation of the boresight beam based at least in part on mapping one or more antenna element phases to one or more elements located at one or more rotated positions associated with the tilt operation. In these examples, a phase of an antenna element used for the tilted boresight beam may be equal to a phase of an antenna element of a non-tilted boresight beam at a corresponding rotated location.

In some aspects, applying the tilt operation to the boresight beam may include applying the tilt operation to the boresight beam in accordance with the one or more characteristics of the UE 120. In one example, the network node 110 may apply a tilt operation that is based at least in part on the location information associated with the UE 120 and the velocity information associated with the UE 120. In another example, the network node 110 may apply a tilt operation that is based at least in part on the location information associated with the UE 120. In another example, the network node 110 may receive satellite information associated with a satellite communicating with a terrestrial device (such as the UE 120 or a terrestrial network node). The network node 110 may determine location information associated with the satellite and velocity information associated with the satellite based at least in part on the satellite information. In this example, the tilt operation applied to the boresight beam at the network node 110 may be based at least in part on the location information and the velocity information associated with the satellite. In another example, the network node 110 may apply a tilt operation that is based at least in part on the one or more throughput metrics associated with the UE 120.

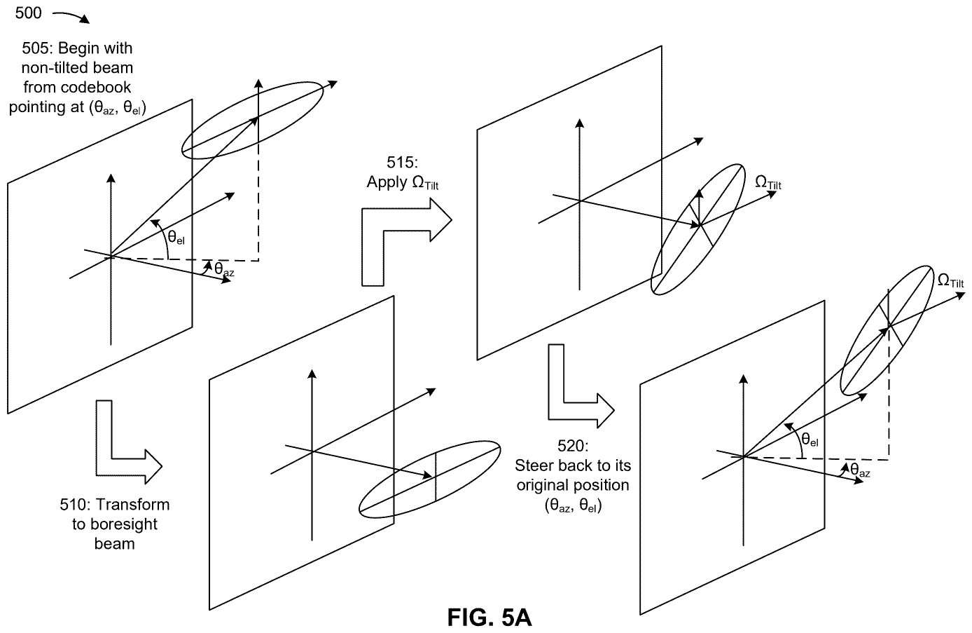

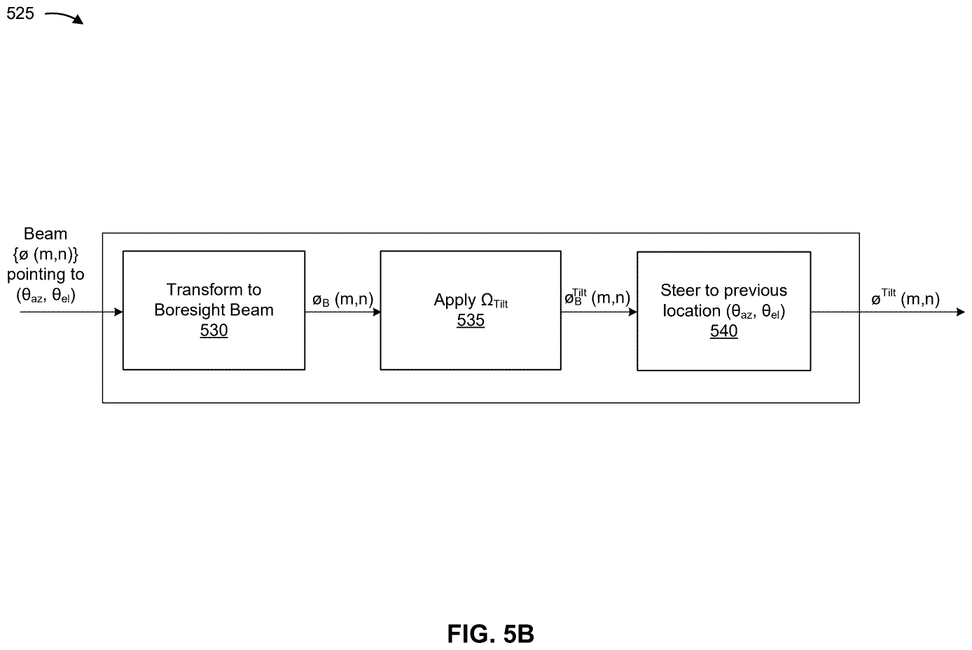

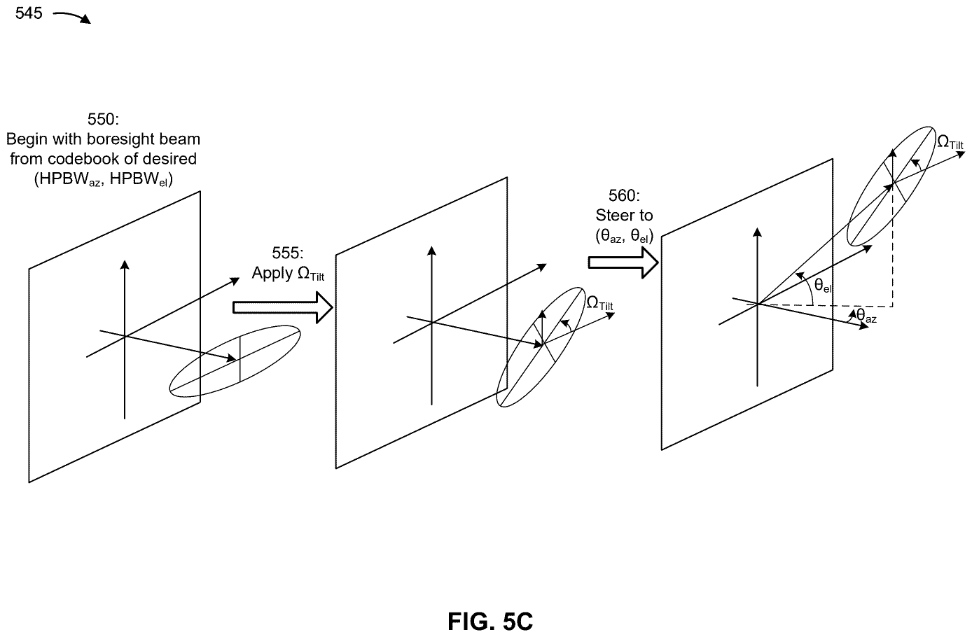

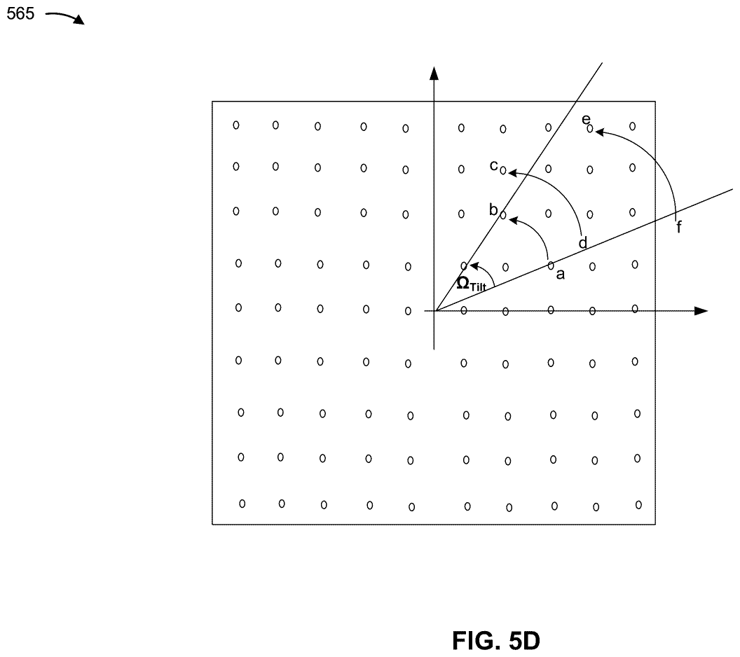

As shown by reference number 420, the network node 110 may steer the tilted boresight beam in accordance with an azimuth parameter and an elevation parameter. In some aspects, steering the tilted boresight beam may include adjusting the tilted boresight beam to a same direction as an original beam (for example, the non-tilted beam) and to a same elevation as the original beam. For example, the network node 110 may steer the tilted boresight beam back to the original direction (θ_{az}, θₑₗ). Additional details regarding these features are described in connection with FIGS. 5A-5D.

As shown by reference number 425, the network node 110 may transmit, and the UE 120 may receive, information associated with the tilted boresight beam. The network node 110 may transmit the information associated with the tilted boresight beam based at least in part on steering the tilted boresight beam in accordance with the azimuth parameter and the elevation parameter.

As shown by reference number 430, the network node 110 and the UE 120 may communicate using the tilted boresight beam.

As indicated above, FIG. 4 is provided as an example. Other examples may differ from what is described with regard to FIG. 4.

FIGS. 5A-5D are diagrams illustrating examples of beam tilting and beam steering, in accordance with the present disclosure.

As shown in FIG. 5A and example 500, in some aspects, the network node 110 may transform a non-tilted beam into a boresight beam and may apply a tilt operation to the boresight beam. As shown by reference number 505, the network node 110 may begin with a non-tilted beam that is selected from a codebook. The non-tilted beam may be pointing in a direction indicated by (θ_{az}, θₑₗ). As shown by reference number 510, the network node 110 may transform the non-tilted beam to a boresight beam. The boresight beam may have a reference azimuth characteristic and a reference elevation characteristic. For example, the boresight beam may be pointing in a same direction as one or more antennas of the network node 110 and may be at a same elevation of the one or more antennas of the network node 110. As shown by reference number 515, the network node 110 may apply a tilt operation to the boresight beam. The tilt operation may be applied using a tilting parameter Ω_{Tilt}. As shown by reference number 520, the network node 110 may steer the tilted boresight beam back to an original position. For example, the network node 110 may steer the boresight beam to be pointing in the direction of (θ_{az}, θₑₗ).

As shown in FIG. 5B and example 525, the network node 110 may obtain a boresight beam {φ_{B} (m,n)} from a beam {φ(m, n)} pointing to (θ_{az}, θₑₗ). In this example, φ(m, n) is a phase applied to an (m, n)^{th} antenna element (where m and n are indices of antenna elements along x and y axes, respectively). As shown by reference number 530, the network node 110 may transform the beam to a boresight beam. For example, the network node 110 may steer the beam pointing at (θ_{az}, θₑₗ) to boresight (0,0) using a beam steering operation. Steering the beam may result in a beam represented by φ_{B} (m,n), where:

$${ϕ}_{B} ( m , n ) = ϕ ( m , n ) - \frac{ω}{c} \{ {md}_{x} cos ( - {θ}_{el} ) sin ( - {θ}_{az} ) + {nd}_{y} sin ( - {θ}_{el} ) \} .$$

As shown by reference number 535, the network node 110 may apply a tilt operation using Ω_{Tilt}. For example, the network node 110 may apply Ω_{Tilt} to the boresight beam using a coordinate rotation-based phase remapping to the one or more antennas of the network node 110. Applying the tilt operation to the boresight beam may result in

$${ϕ}_{B}^{Tilt} ( m , n ) ,$$

where:

$${ϕ}_{B}^{Tilt} ( m , n ) = {ϕ}_{B} ( m cos {Ω}_{Tilt} + \frac{{nd}_{y}}{{d}_{x}} sin {Ω}_{Tilt} , - \frac{{md}_{x}}{{d}_{y}} sin {Ω}_{Tilt} + n cos {Ω}_{Tilt} ) .$$

As shown by reference number 540, the network node 110 may steer the beam to the previous direction (θ_{az}, θₑₗ). This may result in [φ^{Tilt}(m, n)], where:

$${ϕ}^{Tilt} ( m , n ) = {ϕ}_{B}^{Tilt} ( m , n ) - \frac{ω}{c} \{ {md}_{x} cos ( {θ}_{el} ) sin ( {θ}_{az} ) + {nd}_{y} sin ( {θ}_{el} ) \} .$$

As shown in FIG. 5C and example 545, in some aspects, the network node 110 may begin with a boresight beam. This may enable the network node 110 to use fewer codebook RFIC memory resources for storing the boresight beam definitions. In some aspects, the network node 110 may store boresight beams having various half-beam power widths in the codebook memory. These boresight beams having the various half-beam power widths may be tilted and steered to desired directions. As shown by reference number 550, the network node 110 may begin with a boresight beam from a codebook having a desired (HBPW_{az}, HBPWₑₗ). As shown by reference number 555, the network node 110 may apply a tilt operation to the boresight beam having the desired HBPW using Ω_{Tilt}. As shown by reference number 560, the network node 110 may steer the tilted beam having the desired HBPW to the previous location (θ_{az}, θₑₗ).

As shown in FIG. 5D and example 565, in some aspects, the tilt can be performed using an electrical rotation by remapping antenna element phases to elements located at −Ω_{Tilt} rotated positions. In this example,

$${ϕ}_{B}^{Tilt} ( m , n )$$

represents a phase or an antenna element located at (mdₓ, nd_{y}). This may be equal to the phase of the antenna element of the un-tilted boresight beam at the rotated location (mdₓ cos Ω_{Tilt}+nd_{y} sin Ω_{Tilt}, −mdₓ sin Ω_{Tilt}+nd_{y} cos Ω_{Tilt}). In this example:

$${ϕ}_{B}^{Tilt} ( m , n ) = {ϕ}_{B} ( m cos {Ω}_{Tilt} + \frac{{nd}_{y}}{{d}_{x}} sin {Ω}_{Tilt} , - \frac{{md}_{x}}{{d}_{y}} sin {Ω}_{Tilt} + n cos {Ω}_{Tilt} ) ,$$

where:

$${ϕ}_{B}^{Tilt}$$

is the boresight beam plus the tilt, and
φ_{B} is the boresight beam.

In some aspects, the phase of element ‘b’ for the tilted beam is equal to the phase of element ‘a’ of the boresight beam, where ‘a’ is a real element. In some aspects, the phase of element ‘c’ for the tilted beam is equal to the phase of element ‘d’ of the boresight beam, where ‘d’ is a virtual element. In some aspects, the phase of element ‘e’ for the tilted beam is equal to the phase of element ‘f’ of the boresight beam, where ‘f’ is a virtual element. In these examples, ‘b’, ‘c’, ‘e’ are Ω_{Tilt} rotated positions of ‘a’, ‘d’, ‘f,’ respectively. In some other aspects, the tilt operation can be performed using a mechanical rotation of the panel.

As indicated above, FIGS. 5A-5D are provided as examples. Other examples may differ from what is described with regard to FIGS. 5A-5D.

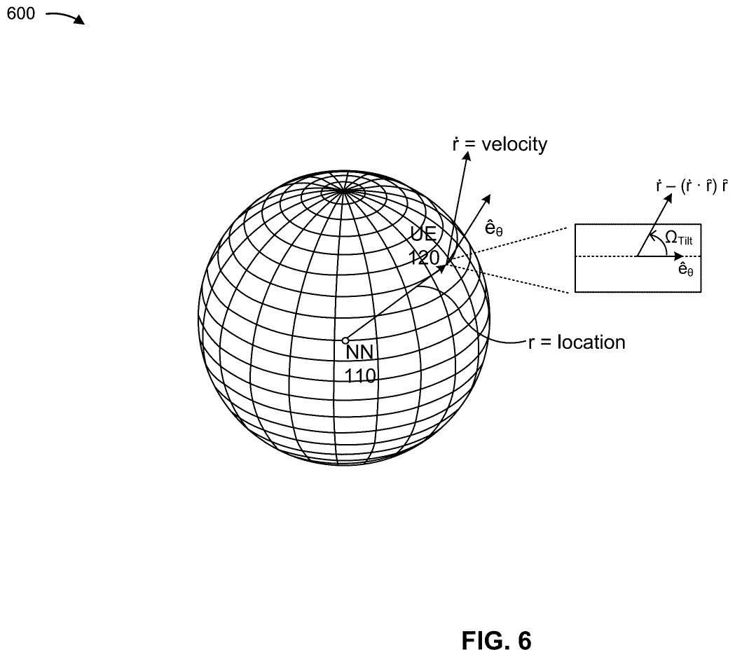

FIG. 6 is a diagram illustrating an example 600 of beam tilting in accordance with user equipment characteristics, in accordance with the present disclosure. As described herein, the UE 120 may transmit one or more characteristics of the UE 120 to the network node 110, and the network node 110 may use the one or more characteristics of the UE 120 for determining a tilt to be applied to a beam.

In some examples, the one or more characteristics of the UE 120 may include location information associated with the UE 120 and velocity information associated with the UE 120. For example, the UE 120 may transmit a time difference of arrival (TDoA) computation by the UE 120 on a downlink pseudo-random sequence (PRS) or a global positioning system (GPS). In these examples, the network node 110 may use the location and velocity information to compute Ω_{Tilt}.

In some examples, the location information associated with the UE 120 and the velocity information associated with the UE 120 may be implicitly signaled to the network node 110. For example, the network node 110 may perform a TDoA computation on an uplink SRS. In these examples, the network node 110 may use the location and velocity information to compute Ω_{Tilt}.

In some examples, the one or more characteristics of the UE 120 may include only the location information associated with the UE 120. This may be used in situations of constrained motion or vehicle highway traffic, among other examples. In these examples, the network node 110 may use the location information to compute Ω_{Tilt}.

In some examples, the one or more characteristics of the UE 120 may include satellite information associated with a satellite in communication with the UE 120. This may be used in the example of a low-earth orbit (LEO) satellite, among other examples. In these examples, the network node 110 may use a satellite identifier (ID) to query real-time databases for the velocity and location information. Subsequently, the network node 110 may use the location and velocity information to compute Ω_{Tilt}.

In some examples, the one or more characteristics of the UE 120 may include one or more throughput metrics associated with the UE 120. For example, the UE 120 may report one or more throughput metrics to the network node 110. In these examples, the network node 110 may use the one or more throughput metrics to compute Ω_{Tilt}.

As shown in the example 600, the UE 120 may have a location (r) and a velocity (\dot{r}). The network node 110 may compute Ω_{Tilt} using the following:

$$\{ \dot{r} - ( \dot{r} \cdot \hat{r} ) \hat{r} \} \cdot {\hat{e}}_{θ} = \vert \{ \dot{r} - ( \dot{r} \cdot \hat{r} ) \hat{r} \} \vert cos ( {Ω}_{Tilt} ) .$$

As indicated above, FIG. 6 is provided as an example. Other examples may differ from what is described with regard to FIG. 6.

FIG. 7 is a diagram illustrating an example process 700 performed, for example, at a network node or an apparatus of a network node, in accordance with the present disclosure. Example process 700 is an example where the apparatus or the network node (e.g., network node 110) performs operations associated with beam adjustment using beam tilting.

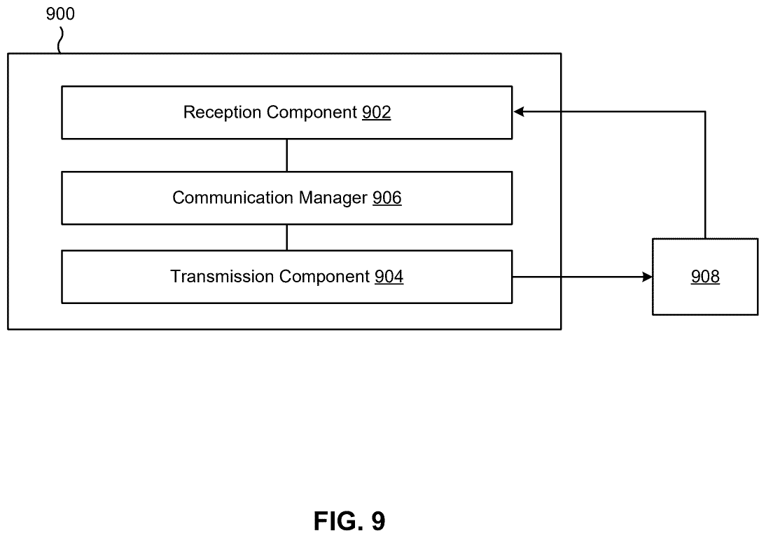

As shown in FIG. 7, in some aspects, process 700 may include obtaining a boresight beam having a reference azimuth characteristic and a reference elevation characteristic (block 710). For example, the network node (e.g., using reception component 902 and/or communication manager 906, depicted in FIG. 9) may obtain a boresight beam having a reference azimuth characteristic and a reference elevation characteristic, as described above.

As further shown in FIG. 7, in some aspects, process 700 may include applying a tilt operation to the boresight beam to obtain a tilted boresight beam (block 720). For example, the network node (e.g., using communication manager 906, depicted in FIG. 9) may apply a tilt operation to the boresight beam to obtain a tilted boresight beam, as described above.

As further shown in FIG. 7, in some aspects, process 700 may include steering the tilted boresight beam in accordance with an azimuth parameter and an elevation parameter (block 730). For example, the network node (e.g., using communication manager 906, depicted in FIG. 9) may steer the tilted boresight beam in accordance with an azimuth parameter and an elevation parameter, as described above.

As further shown in FIG. 7, in some aspects, process 700 may include transmitting information associated with the tilted boresight beam based at least in part on steering the tilted boresight beam in accordance with the azimuth parameter and the elevation parameter (block 740). For example, the network node (e.g., using transmission component 904 and/or communication manager 906, depicted in FIG. 9) may transmit information associated with the tilted boresight beam based at least in part on steering the tilted boresight beam in accordance with the azimuth parameter and the elevation parameter, as described above.

Process 700 may include additional aspects, such as any single aspect or any combination of aspects described below and/or in connection with one or more other processes described elsewhere herein.

In a first aspect, obtaining the boresight beam comprises transforming an original beam into the boresight beam, wherein the original beam is a non-tilted beam having an azimuth characteristic that is in accordance with the azimuth parameter and an elevation characteristic that is in accordance with the elevation parameter.

In a second aspect, alone or in combination with the first aspect, the reference azimuth characteristic indicates that the boresight beam is pointing in a reference azimuth direction and the reference elevation characteristic indicates that the boresight beam is at a reference elevation.

In a third aspect, alone or in combination with one or more of the first and second aspects, the reference azimuth direction is a horizontal direction with respect to one or more antennas of the network node and the reference elevation is an elevation of the one or more antennas of the network node.

In a fourth aspect, alone or in combination with one or more of the first through third aspects, applying the tilt operation to the boresight beam comprises performing a coordinate-rotation-based phase-remapping operation to one or more antennas used for transmitting the boresight beam.

In a fifth aspect, alone or in combination with one or more of the first through fourth aspects, steering the tilted boresight beam comprises adjusting the tilted boresight beam to a same direction as the original beam and to a same elevation as the original beam.

In a sixth aspect, alone or in combination with one or more of the first through fifth aspects, obtaining the boresight beam comprises selecting the boresight beam in accordance with an azimuth half-power beam width of the boresight beam and an elevation half-power beam width of the boresight beam.

In a seventh aspect, alone or in combination with one or more of the first through sixth aspects, process 700 includes storing a plurality of beams in a memory of the network node, each beam of the plurality of beams having a different azimuth half-power beam width and a different elevation half-power beam width.

In an eighth aspect, alone or in combination with one or more of the first through seventh aspects, applying the tilt operation to the boresight beam comprises performing an electrical rotation of the boresight beam based at least in part on mapping one or more antenna element phases to one or more elements located at one or more rotated positions associated with the tilt operation.

In a ninth aspect, alone or in combination with one or more of the first through eighth aspects, a phase of an antenna element used for the tilted boresight beam is equal to a phase of an antenna element of a non-tilted boresight beam at a corresponding rotated location.

In a tenth aspect, alone or in combination with one or more of the first through ninth aspects, process 700 includes receiving location information associated with a UE and velocity information associated with the UE, wherein the tilt operation applied to the boresight beam is in accordance with the location information and the velocity information.

In an eleventh aspect, alone or in combination with one or more of the first through tenth aspects, process 700 includes calculating location information associated with a UE and velocity information associated with the UE, wherein the tilt operation applied to the boresight beam is in accordance with the location information and the velocity information.

In a twelfth aspect, alone or in combination with one or more of the first through eleventh aspects, process 700 includes receiving location information associated with a UE, wherein the tilt operation applied to the boresight beam is in accordance with the location information.

In a thirteenth aspect, alone or in combination with one or more of the first through twelfth aspects, process 700 includes receiving satellite information associated with a satellite communicating with a terrestrial device, and determining location information associated with the satellite and velocity information associated with the satellite based at least in part on the satellite information, wherein the tilt operation applied to the boresight beam at the network node is in accordance with the location information and the velocity information.

In a fourteenth aspect, alone or in combination with one or more of the first through thirteenth aspects, process 700 includes receiving a throughput metric associated with a UE, wherein the tilt operation applied to the boresight beam is in accordance with the throughput metric.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with beam adjustment using beam tilting.

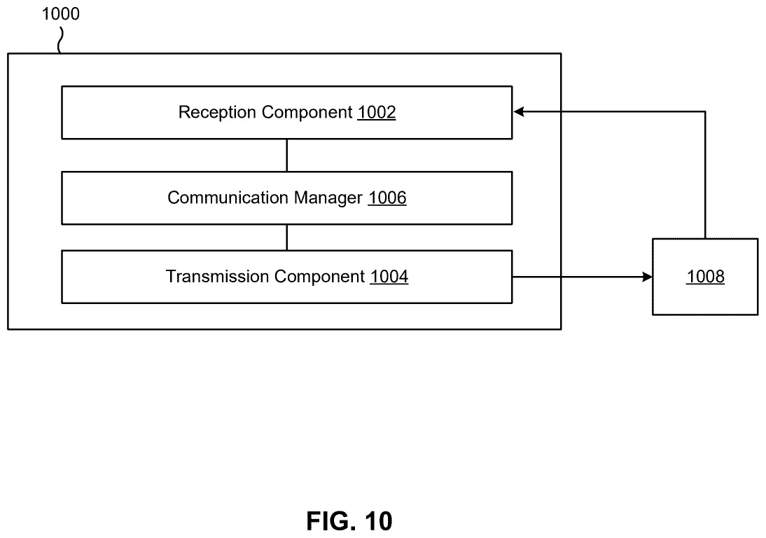

As shown in FIG. 8, in some aspects, process 800 may include transmitting one or more characteristics of the UE (block 810). For example, the UE (e.g., using transmission component 1004 and/or communication manager 1006, depicted in FIG. 10) may transmit one or more characteristics of the UE, as described above.

As further shown in FIG. 8, in some aspects, process 800 may include receiving information associated with a tilted boresight beam, wherein the tilted boresight beam is tilted in accordance with the one or more characteristics of the UE and is steered in accordance with an azimuth parameter and an elevation parameter (block 820). For example, the UE (e.g., using reception component 1002 and/or communication manager 1006, depicted in FIG. 10) may receive information associated with a tilted boresight beam, wherein the tilted boresight beam is tilted in accordance with the one or more characteristics of the UE and is steered in accordance with an azimuth parameter and an elevation parameter, as described above.

As further shown in FIG. 8, in some aspects, process 800 may include communicating with a network node using the tilted boresight beam (block 830). For example, the UE (e.g., using reception component 1002, transmission component 1004, and/or communication manager 1006, depicted in FIG. 10) may communicate with a network node using the tilted boresight beam, as described above.

Process 800 may include additional aspects, such as any single aspect or any combination of aspects described below and/or in connection with one or more other processes described elsewhere herein.

In a first aspect, the one or more characteristics of the UE include location information associated with the UE and velocity information associated with the UE, wherein the tilted boresight beam is tilted in accordance with the location information and the velocity information.

In a second aspect, alone or in combination with the first aspect, the one or more characteristics of the UE include location information associated with the UE, wherein the tilted boresight beam is tilted in accordance with the location information.

In a third aspect, alone or in combination with one or more of the first and second aspects, the one or more characteristics of the UE include satellite information associated with a satellite in communication with the UE, wherein the tilted boresight beam is tilted in accordance with the satellite information.

In a fourth aspect, alone or in combination with one or more of the first through third aspects, the one or more characteristics of the UE include a throughput metric associated with the UE, wherein the tilted boresight beam is tilted in accordance with the throughput metric.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 4-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may obtain a boresight beam having a reference azimuth characteristic and a reference elevation characteristic. The communication manager 906 may apply a tilt operation to the boresight beam to obtain a tilted boresight beam. The communication manager 906 may steer the tilted boresight beam in accordance with an azimuth parameter and an elevation parameter. The transmission component 904 may transmit information associated with the tilted boresight beam based at least in part on steering the tilted boresight beam in accordance with the azimuth parameter and the elevation parameter.

The communication manager 906 may store a plurality of beams in a memory of the network node, each beam of the plurality of beams having a different azimuth half-power beam width and a different elevation half-power beam width. The reception component 902 may receive location information associated with a UE and velocity information associated with the UE, wherein the tilt operation applied to the boresight beam is in accordance with the location information and the velocity information. The communication manager 906 may calculate location information associated with a UE and velocity information associated with the UE, wherein the tilt operation applied to the boresight beam is in accordance with the location information and the velocity information. The reception component 902 may receive location information associated with a UE, wherein the tilt operation applied to the boresight beam is in accordance with the location information. The reception component 902 may receive satellite information associated with a satellite communicating with a terrestrial device. The communication manager 906 may determine location information associated with the satellite and velocity information associated with the satellite based at least in part on the satellite information, wherein the tilt operation applied to the boresight beam at the network node is in accordance with the location information and the velocity information. The reception component 902 may receive a throughput metric associated with a UE, wherein the tilt operation applied to the boresight beam is in accordance with the throughput metric.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 4-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit one or more characteristics of the UE. The reception component 1002 may receive information associated with a tilted boresight beam, wherein the tilted boresight beam is tilted in accordance with the one or more characteristics of the UE and is steered in accordance with an azimuth parameter and an elevation parameter. The reception component 1002 and/or the transmission component 1004 may communicate with a network node using the tilted boresight beam.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a network node, comprising: obtaining a boresight beam having a reference azimuth characteristic and a reference elevation characteristic; applying a tilt operation to the boresight beam to obtain a tilted boresight beam; steering the tilted boresight beam in accordance with an azimuth parameter and an elevation parameter; and transmitting information associated with the tilted boresight beam based at least in part on steering the tilted boresight beam in accordance with the azimuth parameter and the elevation parameter.
Aspect 2: The method of Aspect 1, wherein obtaining the boresight beam comprises transforming an original beam into the boresight beam, wherein the original beam is a non-tilted beam having an azimuth characteristic that is in accordance with the azimuth parameter and an elevation characteristic that is in accordance with the elevation parameter.
Aspect 3: The method of Aspect 2, wherein the reference azimuth characteristic indicates that the boresight beam is pointing in a reference azimuth direction and the reference elevation characteristic indicates that the boresight beam is at a reference elevation.
Aspect 4: The method of Aspect 3, wherein the reference azimuth direction is a horizontal direction with respect to one or more antennas of the network node and the reference elevation is an elevation of the one or more antennas of the network node.
Aspect 5: The method of Aspect 2, wherein applying the tilt operation to the boresight beam comprises performing a coordinate-rotation-based phase-remapping operation to one or more antennas used for transmitting the boresight beam.
Aspect 6: The method of Aspect 2, wherein steering the tilted boresight beam comprises adjusting the tilted boresight beam to a same direction as the original beam and to a same elevation as the original beam.
Aspect 7: The method of any of Aspects 1-6, wherein obtaining the boresight beam comprises selecting the boresight beam in accordance with an azimuth half-power beam width of the boresight beam and an elevation half-power beam width of the boresight beam.
Aspect 8: The method of Aspect 7, further comprising storing a plurality of beams in a memory of the network node, each beam of the plurality of beams having a different azimuth half-power beam width and a different elevation half-power beam width.
Aspect 9: The method of any of Aspects 1-8, wherein applying the tilt operation to the boresight beam comprises performing an electrical rotation of the boresight beam based at least in part on mapping one or more antenna element phases to one or more elements located at one or more rotated positions associated with the tilt operation.
Aspect 10: The method of Aspect 9, wherein a phase of an antenna element used for the tilted boresight beam is equal to a phase of an antenna element of a non-tilted boresight beam at a corresponding rotated location.
Aspect 11: The method of any of Aspects 1-10, further comprising receiving location information associated with a user equipment and velocity information associated with the user equipment, wherein the tilt operation applied to the boresight beam is in accordance with the location information and the velocity information.
Aspect 12: The method of any of Aspects 1-11, further comprising calculating location information associated with a user equipment and velocity information associated with the user equipment, wherein the tilt operation applied to the boresight beam is in accordance with the location information and the velocity information.
Aspect 13: The method of any of Aspects 1-12, further comprising receiving location information associated with a user equipment, wherein the tilt operation applied to the boresight beam is in accordance with the location information.
Aspect 14: The method of any of Aspects 1-13, further comprising: receiving satellite information associated with a satellite communicating with a terrestrial device; and determining location information associated with the satellite and velocity information associated with the satellite based at least in part on the satellite information, wherein the tilt operation applied to the boresight beam at the network node is in accordance with the location information and the velocity information.
Aspect 15: The method of any of Aspects 1-14, further comprising receiving a throughput metric associated with a user equipment, wherein the tilt operation applied to the boresight beam is in accordance with the throughput metric.
Aspect 16: A method of wireless communication performed by a user equipment (UE), comprising: transmitting one or more characteristics of the UE; receiving information associated with a tilted boresight beam, wherein the tilted boresight beam is tilted in accordance with the one or more characteristics of the UE and is steered in accordance with an azimuth parameter and an elevation parameter; and communicating with a network node using the tilted boresight beam.
Aspect 17: The method of Aspect 16, wherein the one or more characteristics of the UE include location information associated with the UE and velocity information associated with the UE, wherein the tilted boresight beam is tilted in accordance with the location information and the velocity information.
Aspect 18: The method of any of Aspects 16-17, wherein the one or more characteristics of the UE include location information associated with the UE, wherein the tilted boresight beam is tilted in accordance with the location information.
Aspect 19: The method of any of Aspects 16-18, wherein the one or more characteristics of the UE include satellite information associated with a satellite in communication with the UE, wherein the tilted boresight beam is tilted in accordance with the satellite information.
Aspect 20: The method of any of Aspects 16-19, wherein the one or more characteristics of the UE include a throughput metric associated with the UE, wherein the tilted boresight beam is tilted in accordance with the throughput metric.
Aspect 21: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-20.
Aspect 22: An apparatus for wireless communication at a device, the apparatus comprising one or more memories and one or more processors coupled to the one or more memories, the one or more processors configured to cause the device to perform the method of one or more of Aspects 1-20.
Aspect 23: An apparatus for wireless communication, the apparatus comprising at least one means for performing the method of one or more of Aspects 1-20.
Aspect 24: A non-transitory computer-readable medium storing code for wireless communication, the code comprising instructions executable by one or more processors to perform the method of one or more of Aspects 1-20.
Aspect 25: A non-transitory computer-readable medium storing a set of instructions for wireless communication, the set of instructions comprising one or more instructions that, when executed by one or more processors of a device, cause the device to perform the method of one or more of Aspects 1-20.
Aspect 26: A device for wireless communication, the device comprising a processing system that includes one or more processors and one or more memories coupled with the one or more processors, the processing system configured to cause the device to perform the method of one or more of Aspects 1-20.
Aspect 27: An apparatus for wireless communication at a device, the apparatus comprising one or more memories and one or more processors coupled to the one or more memories, the one or more processors individually or collectively configured to cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a network node, comprising:
one or more memories; and
one or more processors, coupled to the one or more memories, configured to cause the network node to:
obtain a boresight beam having a reference azimuth characteristic and a reference elevation characteristic;
apply a tilt operation to the boresight beam to obtain a tilted boresight beam;
steer the tilted boresight beam in accordance with an azimuth parameter and an elevation parameter; and
transmit information associated with the tilted boresight beam based at least in part on steering the tilted boresight beam in accordance with the azimuth parameter and the elevation parameter.

2. The apparatus of claim 1, wherein the one or more processors, to cause the network node to obtain the boresight beam, are configured to cause the network node to transform an original beam into the boresight beam, wherein the original beam is a non-tilted beam having an azimuth characteristic that is in accordance with the azimuth parameter and an elevation characteristic that is in accordance with the elevation parameter.

3. The apparatus of claim 2, wherein the reference azimuth characteristic indicates that the boresight beam is pointing in a reference azimuth direction and the reference elevation characteristic indicates that the boresight beam is at a reference elevation.

4. The apparatus of claim 3, wherein the reference azimuth direction is a horizontal direction with respect to one or more antennas of the network node and the reference elevation is an elevation of the one or more antennas of the network node.

5. The apparatus of claim 2, wherein the one or more processors, to cause the network node to apply the tilt operation to the boresight beam, are configured to cause the network node to perform a coordinate-rotation-based phase-remapping operation to one or more antennas used for transmitting the boresight beam.

6. The apparatus of claim 2, wherein the one or more processors, to cause the network node to steer the tilted boresight beam, are configured to cause the network node to adjust the tilted boresight beam to a same direction as the original beam and to a same elevation as the original beam.

7. The apparatus of claim 1, wherein the one or more processors, to cause the network node to obtain the boresight beam, are configured to cause the network node to select the boresight beam in accordance with an azimuth half-power beam width of the boresight beam and an elevation half-power beam width of the boresight beam.

8. The apparatus of claim 7, wherein the one or more processors are further configured to cause the network node to store a plurality of beams in a memory of the network node, each beam of the plurality of beams having a different azimuth half-power beam width and a different elevation half-power beam width.

9. The apparatus of claim 1, wherein the one or more processors, to cause the network node to apply the tilt operation to the boresight beam, are configured to cause the network node to perform an electrical rotation of the boresight beam based at least in part on mapping one or more antenna element phases to one or more elements located at one or more rotated positions associated with the tilt operation.

10. The apparatus of claim 9, wherein a phase of an antenna element used for the tilted boresight beam is equal to a phase of an antenna element of a non-tilted boresight beam at a corresponding rotated location.

11. The apparatus of claim 1, wherein the one or more processors are further configured to cause the network node to receive location information associated with a user equipment and velocity information associated with the user equipment, wherein the tilt operation applied to the boresight beam is in accordance with the location information and the velocity information.

12. The apparatus of claim 1, wherein the one or more processors are further configured to cause the network node to calculate location information associated with a user equipment and velocity information associated with the user equipment, wherein the tilt operation applied to the boresight beam is in accordance with the location information and the velocity information.

13. The apparatus of claim 1, wherein the one or more processors are further configured to cause the network node to receive location information associated with a user equipment, wherein the tilt operation applied to the boresight beam is in accordance with the location information.

14. The apparatus of claim 1, wherein the one or more processors are further configured to cause the network node to:
receive satellite information associated with a satellite communicating with a terrestrial device; and
determine location information associated with the satellite and velocity information associated with the satellite based at least in part on the satellite information, wherein the tilt operation applied to the boresight beam at the network node is in accordance with the location information and the velocity information.

15. The apparatus of claim 1, wherein the one or more processors are further configured to cause the network node to receive a throughput metric associated with a user equipment, wherein the tilt operation applied to the boresight beam is in accordance with the throughput metric.

16. An apparatus for wireless communication at a user equipment (UE), comprising:
one or more memories; and
one or more processors, coupled to the one or more memories, configured to cause the UE to:
transmit one or more characteristics of the UE;
receive information associated with a tilted boresight beam, wherein the tilted boresight beam is tilted in accordance with the one or more characteristics of the UE and is steered in accordance with an azimuth parameter and an elevation parameter; and
communicate with a network node using the tilted boresight beam.

17. The apparatus of claim 16, wherein the one or more characteristics of the UE include location information associated with the UE and velocity information associated with the UE, wherein the tilted boresight beam is tilted in accordance with the location information and the velocity information.

18. The apparatus of claim 16, wherein the one or more characteristics of the UE include satellite information associated with a satellite in communication with the UE, wherein the tilted boresight beam is tilted in accordance with the satellite information.

19. The apparatus of claim 16, wherein the one or more characteristics of the UE include a throughput metric associated with the UE, wherein the tilted boresight beam is tilted in accordance with the throughput metric.

20. A method of wireless communication performed by a network node, comprising:
obtaining a boresight beam having a reference azimuth characteristic and a reference elevation characteristic;
applying a tilt operation to the boresight beam to obtain a tilted boresight beam;
steering the tilted boresight beam in accordance with an azimuth parameter and an elevation parameter; and
transmitting information associated with the tilted boresight beam based at least in part on steering the tilted boresight beam in accordance with the azimuth parameter and the elevation parameter.
